(19) United States
(12) Patent Application Publication
(10) Pub. No.: US 2020/0323215 A1
(43) Pub. Date: Oct. 15, 2020

(54) PESTICIDE FORMULATIONS DERIVED FROM COMBINATIONS OF CARRAGEENANS, SORBIC ACIDS, AND BICARBONATES

(71) Applicant: Ronald Edwin Lane, Colfax, CA (US)

(72) Inventor: Ronald Edwin Lane, Colfax, CA (US)

(73) Assignee: Circadian Crop Sciences LLC, Davis, CA (US)

(21) Appl. No.: 16/378,874

(22) Filed: Apr. 9, 2019

(51) Int. Cl. A01N 59/00; A01N 37/14; A01N 43/16

(52) U.S. Cl. CPC A01N 59/00; A01N 43/16; A01N 37/14

(57) ABSTRACT

The invention describes synergies derived from combinations of bicarbonates, sorbic acids, and carrageenans as formulating agents in pesticides. Bicarbonates are widely used as pesticides in agriculture, though often ineffective unless used in combination with horticultural oils. Horticultural oils are incompatible with sulfur, another common pesticide, which often limits the use of horticultural oils and thus effective applications of bicarbonates. The present invention finds synergies with combinations of carrageenans, sorbic acids, and bicarbonates without an incompatibility with sulfur.

### FIELD OF THE INVENTION

This invention is in the field of pesticide formulation and application. It builds upon integrating principles of agronomy, mycology, bacteriology, agrochemistry, plant protection, and plant physiology.

### BACKGROUND OF INVENTION

The Sumerians began using sulfur compounds for pest control as early as 2500 BC. Since then hundreds if not thousands of pesticides have come into use, with modes of action ranging from acetylcholine esterase inhibitors, to inhibitors of chitin biosynthesis, to the unknown. Some have proven hazardous to humans and the environment. Past applications of DDT have driven avian species to the brink of extinction, and has been linked to a myriad of human ailments, including diabetes, asthma, cancers, and decreased fertility in both men and women. Many preemergent herbicides are groundwater contaminants. Some, pesticides, like methyl bromide, are extremely toxic to humans and also deplete atmospheric ozone. And so many pesticides that come to market eventually are banned or have their use severely limited.

As pesticides are banned or obviated by evolutionary adaptations of pest organisms, new pesticides are developed to fill the voids. These new pesticides are generally birthed by large corporations targeting vital chemical pathways or organs of the pest. Before entering the channels of commerce these pesticides are rigorously tested to standards required by the United States Environmental Protection Agency. Such testing can run into the millions of dollars.

The United States Environmental Protection Agency also allows for certain pesticides to be sold which are exempt from EPA registration. To qualify, these pesticides must be comprised of ingredients recognized as “Minimal Risk” by the US Environmental Protection Agency, as outlined in the Federal Insecticide, Fungicide, And Rodenticide Act (FIFRA) under the Minimum Risk Exemption regulation in 40 CFR 152.25(t). Over 800 US EPA exempt active and inert pesticide ingredient are listed in FIFRA 25(a) and FIFRA 25(b). FIFRA also allows an exemption for ingredients not on the afore mentioned list, but commonly consumed as food. This adds hundreds of more possible ingredients that can go into developing minimum risk pesticides. With eight hundred minimal risk ingredients there are 319,600 different ways to couple them, 85,013,600 possible combinations of three, and close to 17 billion combinations of four. With any combination of ingredients the percentage of each may vary, and thus the possible recipes are virtually endless.

Of particular interest with respect to the present invention are the US EPA minimum risk ingredients: potassium sorbate, bicarbonates, carrageenan, and horticultural oils.

Potassium sorbate, a salt of sorbic acid, is listed as a FIFRA 25(a) minimum risk ingredient. It is widely used as a food preservative (Ekland 1983), but the Pesticide Action Network (PAN) Pesticide Database shows it as an ingredient in but one pesticide product in the United States, one used for controlling secondary fermentations in wine making.

Carrageenan is listed as a FIFRA 25(b) inert ingredient. It shows within the PAN Pesticide Database as a spray adjuvant, but is not shown as an ingredient in any pesticide product ever registered United States. Carrageenans are a family film forming polymers of linear sulfated polysaccharides derived from red seaweed. Other polymers are widely used as spray adjuvants within the agricultural and horticultural industries (Backman 1978). The main functions of polymers as spray adjuvants are to reduce weathering of active ingredients and extend pesticide efficacy. They also function as stickers/spreaders to improve the distribution and adherence of agrochemicals to plant surface. Another agricultural use of polymers is to act as antitranspirants to decrease water loss and wilting (Gale and Hagan 1996). Subsequent studies have found that film forming polymers can be applied as protective barriers over leaf surfaces to protect tissue against invading foliar diseases (Han 1990). For example, film-forming polymers have been shown useful in controlling pathogenic fungi such as rust (Puccinia, Uromyces spp.), gray mold (Botrytis cinerea Pers.), eyespot (Septoria nodorum Berk.), and leaf spot (Pyrenophora spp.), economically important diseases of cereals, vegetables, fruit, and ornamentals (Marco et al. 1994; Sutherland and Walters 2001, 2002).

Bicarbonate and bicarbonate salts, such as potassium bicarbonate and sodium bicarbonate, are recognized by the US EPA as minimal risk inert ingredients. Bicarbonates are also found as active ingredients in US EPA registered pesticides. Traditionally, bicarbonates are used to control powdery mildew diseases of plants, but have shown efficacy against pathogenic species of Alternaria, Botrytis, and Fusarium (Zacker, 2014). They have also been combined with certain horticultural oils (Williams and Williams 1992) to increase efficacy.

Issued in 1925, U.S. Pat. No. 1,560,558 discloses the use of salts such as lithium carbonate, sodium carbonate, sodium bicarbonate, potassium bicarbonate, potassium carbonate and ammonium bicarbonate as fungicide ingredients.

U.S. Pat. No. 5,468,716 discloses the use of bicarbonates with the film-forming polymer xanthan gum.

U.S. Pat. No. 5,468,715 provides a novel fungicide containing bicarbonates coupled with nitrogen, phosphorus, and potassium fertilizer elements.

U.S. Pat. No. 5,342,630 provides a novel pesticide composition combining bicarbonates with certain fatty acids.

Horticultural oils, such as mineral oils, may also comprise minimum risk pesticides. They are widely used in agriculture, and kill insects by plugging the pores in their exoskeletons, thus suffocating them. They enhance the efficacy of bicarbonates as fungicides when mixed with them. However, horticultural oils mixed with sulfur containing compounds, or sprayed shortly after or before the application of sulfur bearing products, can cause severe phytotoxic effects. Sulfur, one of the first pesticides ever used, is still one of the most commonly used pesticides, but sulfur use often limits the option of applying bicarbonates with horticultural oils.

### SUMMARY OF INVENTION

The present invention consists of any combination, mixed in any succession, of sorbic acid and any of its salts (i.e. potassium sorbate, sodium sorbate, calcium sorbate), and/or a bicarbonate and any of its salts (i.e. sodium bicarbonate, ammonium bicarbonate, potassium bicarbonate), and one or both formulated with a carrageenan in any of its forms (i.e. Kappa carrageenan, Iota carrageenan, Lambda carrageenan) for use as formulating agents in pesticides (fungicides, bactericides, insecticides, acaricides, herbicides, and nematicides).

Of the three ingredients only bicarbonates receive wide usage in agricultural pest control. It is known by those proficient in the art that coupling bicarbonates with horticultural oils greatly increases the efficacy of bicarbonates as fungicides. It is also known by those proficient in the art that oils react with sulfur residues on foliage which often causes severe phytotoxicity, thus limiting the use of such combination. The invention finds synergies between bicarbonates and carrageenans comparable or superior to the synergy of combining bicarbonates with horticultural oils, but without an incompatibility with sulfur. The invention further finds synergies when a sorbic acid is combined with a carrageenan.

In one embodiment, a bicarbonate is coupled with a carrageenan to provide an improved curative effect on powdery mildews and rusts. Used alone, bicarbonates do not provide residual protection against fungal diseases, but when bound with a carrageenan they dry as a protective film. The combination also imparts a measure of miticidal and insecticidal efficacy, likely from plugging of trachea and/or altering the permeability of membranes within their spiracles.

In one aspect, a sorbic acid is combined with a bicarbonate to more effectively degrade the cell wall of pathogens that either product used alone.

In another aspect, a sorbic acid is combined with a carrageenan, resulting in increased acute fungicidal and bactericidal efficacy and a lengthening of residual efficacy.

In a further embodiment, a sorbic acid and a bicarbonate are combined with a carrageenan to create complex molecules with pesticidal activities against a broad range of plant pathogens and arthropod pests that dries to a protective film.

### BRIEF DESCRIPTION OF THE DRAWINGS

FIG. 1 describes the dissociation of potassium sorbate in water and the theorized interaction of those products with a carrageenan. FIG. 2 depicts the dissociation of ammonium bicarbonate in water and the possible interaction of those products with a carrageenan. FIG. 3 describes a possible complex formed between a carrageenan and a mixture of bicarbonates and potassium sorbate.

### DETAILED DESCRIPTION OF THE INVENTION

### Definitions

Bicarbonate: any salt containing the HCO₃⁻ anion, typically NaHCO₃, KHCO₃, and NH₄HCO₃.
Carrageenan: a family of linear sulfated polysaccharides (Kappa, Iota, and Lambda forms), extracted from red edible seaweeds, and that differ primarily by the number and position of the ester sulfate groups on the repeating galactose units. They are widely used in the food industry for their gelling, thickening, and stabilizing properties. Their main application is in dairy and meat products due to their strong binding of proteins.
Conidia: asexual, non-motile spores of a fungus.
Dissociation: for the purposes of this document, dissociation refers to the splitting of a molecule into smaller molecules or ions in water by a reversable process.
Efficacy: the ability to produce a desirable or intended result.
FIFRA: The Federal Insecticide, Fungicide, and Rodenticide Act is a United States federal law that set up the basic U.S. system of pesticide regulation to protect applicators, consumers, and the environment.
Hyphae: a long, branching filamentous structure of a fungus.
Minimum Risk Exemption: for the purpose of this document refers to 40 CFR 152.25(t) of The Federal Insecticide, Fungicide, And Rodenticide Act, which specifies certain ingredients exempt from US Federal pesticide registration requirements.
Pesticide: a chemical composition that exerts a desirable effect on a pest species, and depending upon activity, be considered by those skilled in the art to be any of: insecticides, acaricides, fungicides, bactericides, nematicides, and herbicides.
Phytotoxic: negative affect on plant tissues and/or growth resulting from chemical exposure.
Sorbic acid: any salt containing sorbic acid (i.e. potassium sorbate, calcium sorbate, sodium sorbate).
Surfactant: a substance which tends to reduce the surface tension of a liquid in which it is dissolved. In agriculture they are used to prevent spray droplets from beading on foliage and to instead spread spray droplets as a film over leaf surfaces.

### DESCRIPTION

The invention describes synergies between sorbic acids, bicarbonates and carrageenans for use as pesticides.

### Bicarbonates

Bicarbonates are a staple for cooking in most households and are commonly used as fungicides in agriculture. They act upon cell walls and membranes of pathogens, where they affect permeability, which leads to collapse of cell walls and destruction of membranes. In many cases bicarbonates are only effective if mixed with a horticultural oil. The use of horticultural oils is often limited by the practice of sulfur dusting and sulfur bearing sprays, as oils combined with sulfur are known to cause phytotoxic reactions. This often limits the use of bicarbonates in agriculture.

### Sorbic Acids

Sorbic acids are widely used as food preservatives. The mode of action is thought to occur at the cell membrane (Mendonca. 1992) of fungi and bacteria, where it may affect permeability and interrupt metabolic pathways. Within pathogenic organisms, sorbic acid may also affect a number of cellular enzymes and biological processes. Sorbic acid also has a strong inhibitory effect on fungal conidia germination, possibly from blocking enzymes responsible for germination.

Potassium sorbate is perhaps the most commonly used salt of sorbic acid. It hydrolyzes in water to form sorbic acid and potassium ions. The sorbic acid fraction of said solution is a more efficacious antimicrobial than potassium sorbate. While potassium sorbate readily hydrolyzes with water, sorbic acid is weakly soluble in water, and thus solutions of potassium sorbate in water contain but a small fraction of sorbic acid.

### Carrageenans

Carrageenans are a family of linear sulfated polysaccharides (Kappa, Iota, and Lambda forms) extracted from red edible seaweeds, and that differ primarily by the number and position of the ester sulfate groups on the repeating galactose units. Carrageenans are used extensively within the food industry as a thickener, and for their property of binding with other complex molecules, such as amino acids and proteins.

Carrageenans' complex structure forms polymeric films. While carrageenans receive little to no use as pesticide ingredients, polymetric films are known to positively affect the activity of certain pesticides by extending residual efficacy and improving spray coverage. Used alone, film forming polymers may provide a measure of protection against certain pathogens by encapsulating conidia and serving as a physical barrier to prevent pathogens from infecting a host.

### Carrageenans/Bicarbonates Synergy

It is a finding of the invention that efficacy of bicarbonate-based pesticides is enhanced from combining with carrageenans. Carrageenans are high in potassium ions. Potassium differs from other essential plant nutrients as it is not a component of chemical compounds in plants. Potassium ions are highly mobile within plant, readily crossing cell membranes. It is believed that when a membrane gains permeability from the effects of a bicarbonate, excess potassium ions in carrageenan enter the cell, increasing the osmotic potential within the cell, which results in a net flow of water into the cell, and in a process called cytolysis, the cell or hyphae burst. Part of the synergy between bicarbonates and carrageenan may also result from the complex molecules formed between them as depicted in FIG. 2. These complexes may form a protective shield over potential hosts. These complexes may also increase contact time between bicarbonates and pathogens by extending the time required for sprays to dry.

### Carrageenans/Sorbic Acid Synergy

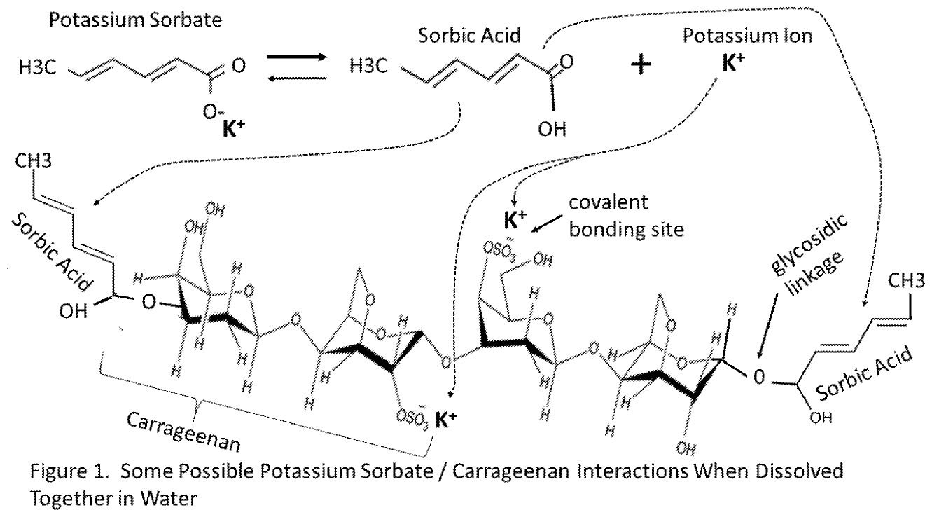

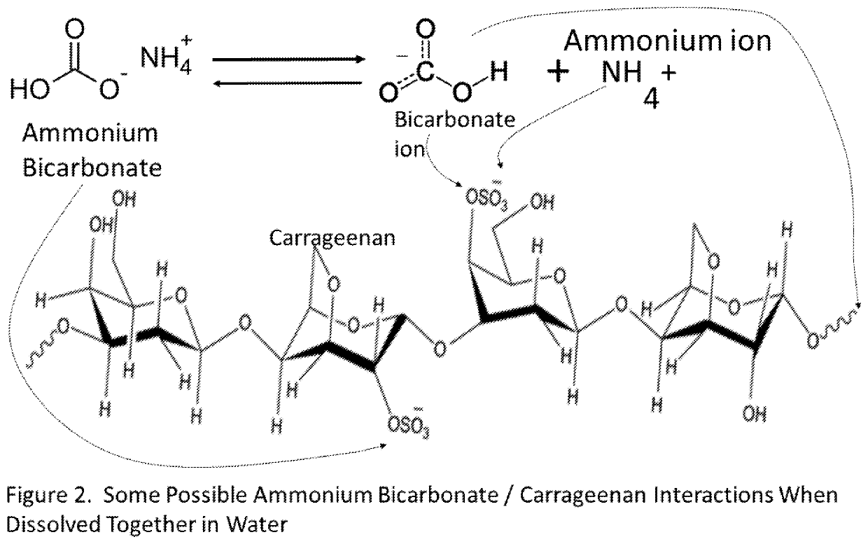

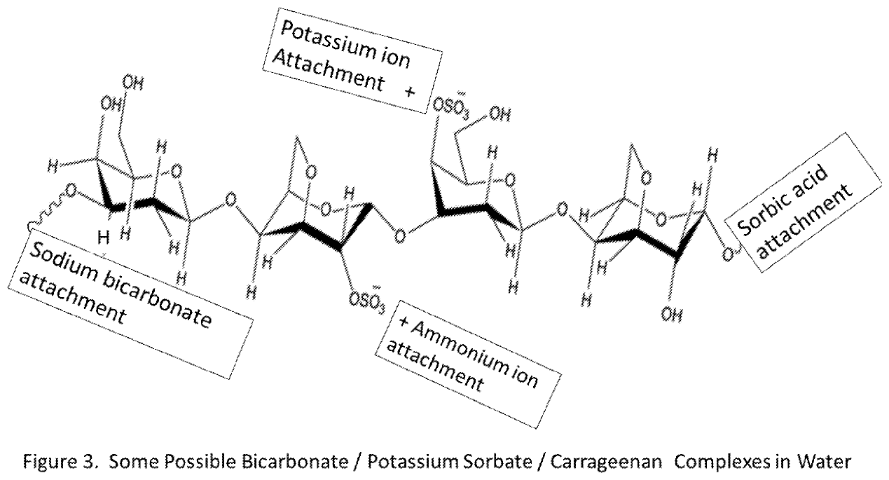

It is a further part of the discovery of this invention that carrageenans synergize sorbic acids. This synergy is believed to work in several ways. It increases the dissociation of a sorbic acid salt to sorbic acid by: 1. raising the pH, which increases the solubility of sorbic acid, and 2. sorbic acid is likely bound via α-1,3 and β-1,4 glycosidic linkages to carrageenan as depicted in FIG. 1, and through linkages with ester sulfate groups. This molecule remains either in suspension or as water soluble molecule. As free sorbic acid in solution binds with carrageenan, more sorbic acid salt dissociates within the solution into sorbic acid and salt ions. In this manner a relatively high percentage for sorbic acid (the better antimicrobial) is created from hydrolyzing a given quantity of sorbic acid.

### Bicarbonates/Sorbic Acids Synergy

It is part of the invention that synergies result from combining a bicarbonate with a sorbic acid. Both affect cell membranes, but by different modes. The weakening of the cell wall by bicarbonates may enhance sorbic acid's ability to penetrate the cell wall of a pathogen where it can disrupt biological processes.

### Sulfur Compatibility

It is the discovery of the invention that carrageenans and/or sorbic acids can be used to enhance bicarbonates without the phytotoxic interactions with sulfur seen when horticultural oils are used to synergize bicarbonates.

### Sorbic Acids/Bicarbonates/Carrageenans Complexes

It is the further finding of this invention that an array of effective pesticides can be derived from combinations of sorbic acids, bicarbonates and carrageenans by varying the salt of the bicarbonate and sorbic acid, along with the ratios of ingredients. Potassium and sodium bicarbonate combinations with carrageenans and potassium sorbate will tend to increase efficacy against foliar diseases. Ammonium bicarbonate in combinations with carrageenan and potassium sorbate will tend to increase efficacy against stem and root diseases. Increasing the sorbic acid fraction will tend to increase efficacy against bacterial pathogens and fungi untouched by bicarbonates. Increasing the carrageenan fraction of the pesticide will tend to increase efficacy towards arthropod pests, likely from affecting the permeability of spiracle membranes and from plugging exoskeletal trachea. FIG. 3 depicts a possible molecule formed from the interaction of these ingredients in water.

### Contribution to the Art

Typically, carrageenan, bicarbonates, and potassium sorbate are available as dry powders or pellets that are easily blended and readily dissolve in water. They are widely used as food additives and hence safe for humans. The US EPA recognizes these ingredients as safe for the environment. The invention adds to the art, an art with a bad reputation for its hazards to humans and environment, by offering a new family of safe and effective pesticides.

Details for blending and using carrageenan, bicarbonate, and potassium sorbate derived pesticides are described in the following examples:

### EXAMPLES

### Example 1

One hundred grams of potassium bicarbonate is blended with one hundred grams of carrageenan. The resulting product is then mixed with water at a rate of two to four teaspoons per gallon along with a surfactant, and sprayed using standard agricultural equipment at the lower rate to prevent powdery mildew on a given crop, or at the higher rate to knockdown or eradicate the disease.

In experiments, sprays of sodium bicarbonate mixed at 1 tablespoon per gallon of water proved ineffective at eliminating infestations of powdery mildew in nursery grown roses, gerbera daisies, ornamental peas, trumpet vines, chrysanthemums, and grapevines, whereas the afore describe mixture of potassium bicarbonate with carrageenan eradicated the disease on all but the oldest leaves, this because as powdery mildew hyphae age their cell walls thicken and they become harder to kill. Powdery mildew that had overwintered on ornamental pea leaves were unaffected by either treatment.

### Example 2

Fifty grams of potassium sorbate is blended with one hundred grams of carrageenan. The resulting product is mixed with water at a rate of two to four teaspoons per gallon and sprayed over orchids at five to ten-day intervals to prevent bacterial spotting.

In tests, potassium sorbate sprayed on affected plants at 1 tablespoon per gallon of water proved ineffective at eliminating infestations of powdery mildew in nursery grown roses, gerbera daisies, ornamental peas, trumpet vines, chrysanthemums, and grapevines, whereas a mixture of potassium sorbate and carrageenan eradicated the freshest cases of the disease at a rate of four teaspoons per gallon of water. Older hyphae of the disease organism were unaffected.

### Example 3

Fifty grams of potassium sorbate and fifty grams of sodium bicarbonate are mixed with one hundred grams of carrageenan. The resulting product is mixed with water at a rate of two to four teaspoons per gallon of water and sprayed over a tomato crop to control Tomato Russet Mite (Aculops lycopersici).

In tests, mixtures of potassium sorbate, with or without potassium bicarbonate, had no effect on Tomato Russet Mites found on young tomato plants naturally infested with the pest organism, whereas sprays of potassium sorbate with sodium bicarbonate combined with carrageenan killed russet mites within forty-eight hours.

### Example 4

One hundred grams of ammonium bicarbonate and one hundred grams of potassium sorbate are blended. The resulting product is mixed with water at a rate of two tablespoons per gallon and applied as a drench around vegetable transplants to inhibit root pathogens such as fusarium spp. While this recipe has yet to be field tested, it is known that ammonium bicarbonate and potassium bicarbonate have both shown efficacy against fusarium separately in the literature. As a synergy between the two products has been theorized in paragraph [0035], and demonstrated in testing on powdery mildew infested plants, the combination of potassium bicarbonate with potassium sorbate is likely to show a synergy in controlling fusarium diseases.

The claimed invention is:

1. A recipe for pesticides wherein a sorbic acid is combined with a bicarbonate for controlling fungi, bacteria, and arthropods affecting structures, agricultural commodities, plant nurseries, forests, landscapes, and home gardens, wherein the bicarbonate constitutes over 100 parts per million in the final solution and is therefore more than an incidental component.

2. A recipe for pesticides wherein a sorbic acid is combined with a carrageenan for controlling fungi, bacteria, and arthropods affecting structures, agricultural commodities, plant nurseries, forests, landscapes, and home gardens.

3. A recipe for pesticides wherein a bicarbonate is combined with a carrageenan for controlling fungi, bacteria, and arthropods affecting structures, agricultural commodities, plant nurseries, forests, landscapes, and home gardens, wherein the bicarbonate constitutes over 100 parts per million in the final solution and is therefore more than an incidental component.

4. A recipe for pesticides wherein a sorbic acid is combined with a bicarbonate and a carrageenan for controlling fungi, bacteria, and arthropods affecting structures, agricultural commodities, plant nurseries, forests, landscapes, and home gardens, wherein the bicarbonate constitutes over 100 parts per million in the final solution and is therefore more than an incidental component.
